(19) United States
(12) Patent Application Publication
(10) Pub. No.: US 2007/0228096 A1
(43) Pub. Date: Oct. 4, 2007

(54) Backpack structure combined with pull-carrier device

(76) Inventor: Che-Wen Lin, Junghe City (TW)

Correspondence Address: Che-Wen LIN, P.O. Box No. 6-57, Junghe, Taipei, 235, omitted

(21) Appl. No.: 11/730,216

(22) Filed: Mar. 30, 2007

(30) Foreign Application Priority Data
Mar. 31, 2006 (TW) 095205611

(51) Int. Cl. A45C 5/14; B62B 1/00; A45C 7/00; A45C 13/30; A45C 15/00

(52) U.S. Cl. 224/576; 190/103; 190/115; 190/18 A; 280/47.18

(57) ABSTRACT

A backpack structure combined with pull-carrier device, which is provided with transformation spaces for retaining articles, and achieves multifunctionality that enables a person to carry the backpack on the back, the shoulders or by hand. The backpack is mainly structured from a basic bag, different sides of which are connected to transformation portions, which enable transformation of the basic bag to form various expanded or contracted states, and thereby providing a carrying device with functionality to achieve flexible adjustment of internal capacity. In addition, a pull-carrier device is movably fitted juxtaposed to a back carrying side of the body of the basic bag configured with straps. Furthermore, when using the straps to carry the backpack on the back, the pull-carrier device will not cause uncomfortableness in the back of a user, and a wheel portion of the pull-carrier device will not soil the back of the user.

### BACKGROUND OF THE INVENTION

(a) Field of the Invention

The present invention relates to a backpack structure combined with pull-carrier device, and more particularly to a bag device having application to facilitate a user to pack and transport articles, and a configuration provided with spatial transformation for retaining of articles therein and multifunctionality to accommodate different uses.

(b) Description of the Prior Art

Conventional carrying devices for loading articles that provides for transporting the goods at the same time as when a person is walking basically include handbags, backpacks or suitcases provided with an extensible bar that enables pulling of the suitcase.

Referring to FIG. 1, which a shows a conventional suitcase (bag) primarily comprising a main body A1, a pull bar A5 and a wheel portion A6, wherein in order to transform the holding space of the suitcase, male and female juxtaposed zip fasteners A2, A3 are disposed on a side opposite to the pull bar A5 of the suitcase (bag) body, and expansion of transformation space between the male and female juxtaposed zip fasteners A2, A3 is used to alter capacity of the suitcase (bag), and thereby obtain enlargement of the holding space. However, because the aforementioned conventional structure is limited by the design that only enables the transformation space formed between the male and female juxtaposed zip fasteners A2, A3 to be configure on a single side of the main body A1, thus, an oversized transformation space forms a disproportional corresponding stress on the wheel portion A6 that easily results in the suitcase (bag) falling over and overturning, which is an extremely unideal. In addition, transformation space designs of current related suitcases (bags) are limited to a single function, for example, although certain types of suitcases (bags) are provided with a transformation space configuration, however, they are limited to pulling along the ground for transporting articles, and are not suitable for carrying on the back, the shoulders or carrying by hand. Moreover, certain backpacks and shoulder bags are only suitable for carrying on the body of the user, and are not suitable for pulling along the ground for transporting articles. The main reasons that the aforementioned carrying device products are limited to a single function can be generalized as follows:

(1) Wheeled suitcases (bags) that can be pulled along the ground for transporting articles are mainly designed with the objective for loading and transporting relatively many belongings or articles, and even if they are configured with a transformation space function, the transformation space they are able to produce is limited, and is still confined to the range of large-scale transportation carrying devices. If such carrying devices are carried on the back, the shoulders or by hand, then it will inevitably result in the body having to bear the hardship of carrying a heavy load.

(2) Carrying devices that are carried on the shoulders or by hand are mainly designed with functionality for carrying simple and convenient articles for daily use. However, because the objectives of the carrying devices are lightness and portability, thus, there is no need to consider the additional configuration of wheels for pulling along the ground for transporting articles.

(3) Carrying devices that are carried on the back have functionality between the two aforementioned carrying devices. Because of the method of carrying on the back, thus, a weight load is balanced on the body and does not require strenuous effort to carry. Hence, recent years have seen widespread use of such carrying devices when hiking, going on an outing or journey, or daily travel. However, back carrying devices on sale in the current market are not provided with an adequate transformation holding space configuration. Such types of products still merely consider the needs of specific users. For example: use when hiking or traveling requires a carrying device with large capacity, whereas use for daily travel requires a carrying device with small capacity. The main reasons for the difficulty in making a breakthrough in the original design of current conventional products lie in: (a) inability to effect large area transformation of holding space, (b) a wheeled pull-carrier device, when configured on the back carrying side, results in contact with the back of the body that causes uncomfortableness, (c) when pulling a wheeled pull-carrier device along the ground to transport articles, possible dragging long the ground of sagging straps results in soiling thereof.

In light of the shortcomings of conventional prior art products, the present invention has made a breakthrough in design and provides a carrying device that is able to achieve a multiplicative variation in the space for retaining articles and stowage capacity, and is characterized in providing a multifunctional combined configuration which enables a person to carry the device on the back, the shoulders, by hand or pulled on wheels. Furthermore, at the same time resolves the shortcomings of uncomfortableness to the user when carrying on the back, sagging of straps when pulling along the ground to transport articles, and so on.

### SUMMARY OF THE INVENTION

A primary objective of the present invention is to provide a backpack structure combined with pull-carrier device, wherein transformation portions provided with spatial transformation functionality are respectively connected to left and right sides or an upper side of a basic bag, thereby providing a stowage device that can be carried on the back and achieve an multiplicative increase or decrease in the space for retaining articles and stowage capacity.

Another objective of the present invention is to provide the backpack structure combined with pull-carrier device, wherein a wheeled pull-carrier device is disposed on a juxtaposed side of a back carrying side of the basic bag using a detachable movable method. When the basic bag is expanded and holds many articles, then a wheel portion configured to the pull-carrier device can be used to pull the backpack along the ground to transport the articles. When the goods to be transported are of excessively large size, then the pull-carrier device can be separated from the basic bag and used to carry and transport the goods.

A fourth objective of the present invention is to provide the backpack structure combined with pull-carrier device, wherein a top portion of the basic bag is configured with a top cover structured from a combination of an inner strip, a plurality of outer strips and top contracting members. Each of the plurality of outer strips is configured with a notch portion and radially arranged on the upper surface of the inner strip, thereby forming a first transformation area between the plurality of outer strips and the inner strip to achieve expanding and contracting functionality of the top cover. Furthermore, combination of the notch shapes from each of the notch portions enables forming a variation of patterns.

A fifth objective of the present invention is to provide the backpack structure combined with pull-carrier device, wherein the basic bag is configured with a bottom portion and a bottom contracting member.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of a prior art product.

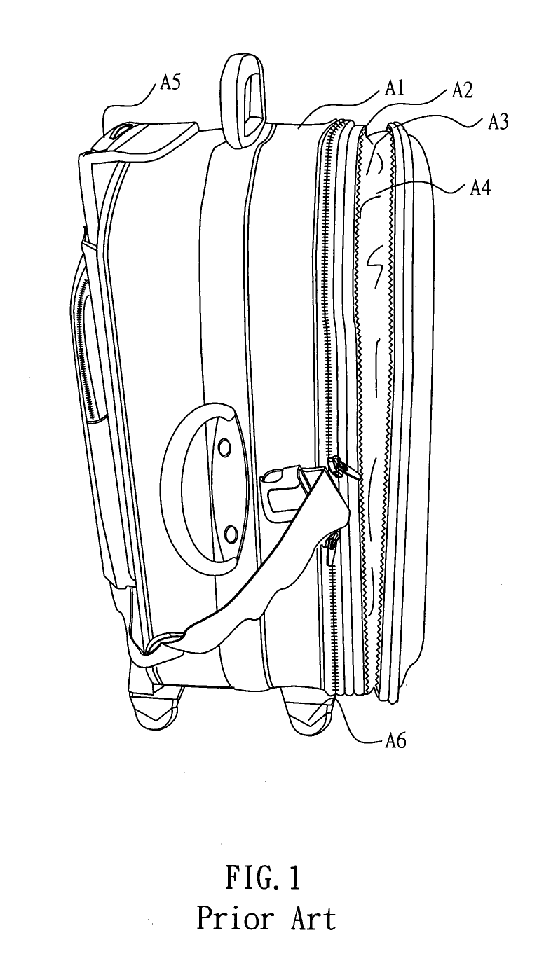

FIG. 2 shows an elevational view according to the present invention.

FIG. 3 shows an elevational view of another side of the present invention.

FIG. 4 shows a schematic view of an embodiment of FIG. 3.

FIGS. 5, 6 and 7 show top views depicting operating method to pull together transformation portions according to the present invention.

FIG. 8 shows a top view after pulling together the transformation portions according to the present invention.

FIG. 9 shows an exploded elevational view depicting relationship between a pull bar and a basic bag according to the present invention.

FIG. 10 shows a schematic view depicting an expanded state of the present invention used in a cylindrical bag.

FIG. 11 shows a schematic view depicting a contracted state of the present invention used in a cylindrical bag and the open state of a front cover.

FIG. 12 shows a schematic view depicting the present invention used in a cylindrical bag in an expanded state combined with a pull-carrier device.

FIG. 13 shows a schematic view depicting assembly and disassembly of the present invention used in a cylindrical bag in an expanded state combined with a pull-carrier device.

FIG. 14 shows a schematic view depicting contracting action of the transformation portions of the present invention used in a cylindrical bag.

FIG. 15 shows a schematic view depicting an open state of the front cover of the present invention used in a cylindrical bag.

FIG. 16 shows a schematic view depicting the opened front cover of the present invention used in a cylindrical bag and retaining state of folding and disposing in a side retaining portion.

FIG. 17 shows a schematic view depicting the opened front cover of the present invention used in a cylindrical bag and the retained state after disposing in the side retaining portion.

FIG. 18 shows a schematic view depicting the retained state after closing the front cover of the present invention used in a cylindrical bag.

FIG. 19 shows a schematic view depicting both the front cover and a front opening of the present invention used in a cylindrical bag in an open state.

FIG. 20 shows a schematic view depicting a top cover opened up from the basic bag of the present invention used in a cylindrical bag.

FIG. 21 shows a schematic view depicting a combined state of the present invention used in a cylindrical bag.

FIG. 22 shows a schematic view depicting the top cover of the present invention used in a cylindrical bag in an expanded state.

FIG. 23 shows a schematic view depicting the top cover of the present invention used in a cylindrical bag in a contracted state.

FIG. 24 shows a schematic view depicting another embodiment of the top cover of the present invention used in a cylindrical bag in a expanded state.

FIG. 25 shows a schematic view depicting another embodiment of the top cover of the present invention used in a cylindrical bag in a contracted state.

FIG. 26 shows a schematic view depicting yet another embodiment of the top cover of the present invention used in a cylindrical bag in a contracted state.

FIG. 27 shows a schematic view depicting a bottom portion of the present invention used in a cylindrical bag in an expanded state.

FIG. 28 shows a schematic view depicting the bottom portion of the present invention used in a cylindrical bag in a contracted state.

FIG. 29 shows another schematic view depicting the bottom portion of the present invention used in a cylindrical bag in an expanded state.

FIG. 30 shows another schematic view depicting the bottom portion of the present invention used in a cylindrical bag in a contracted state.

FIG. 31 shows a schematic view depicting transverse expansion of capacity of the transformation portions according to the present invention.

FIG. 32 shows a partial schematic view depicting transverse contraction of capacity of the transformation portions according to the present invention.

FIG. 33 shows a partial schematic view depicting transverse expansion of capacity of the transformation portions according to the present invention.

FIG. 34 shows a partial schematic view depicting transverse expansion of capacity of the transformation portions according to the present invention.

FIG. 35 shows a schematic view depicting upward extending expansion of capacity according to the present invention.

FIG. 36 shows a structural schematic view depicting simultaneous application of spacers between the transformation portions and an extended portion and the basic bag according to the present invention.

FIG. 37 shows a side schematic view depicting simultaneous application of the expanded state of the transformation portions and the extended portion and an open state of a side opening of the transformation portion according to the present invention.

### DETAILED DESCRIPTION OF THE PREFERRED EMBODIMENTS

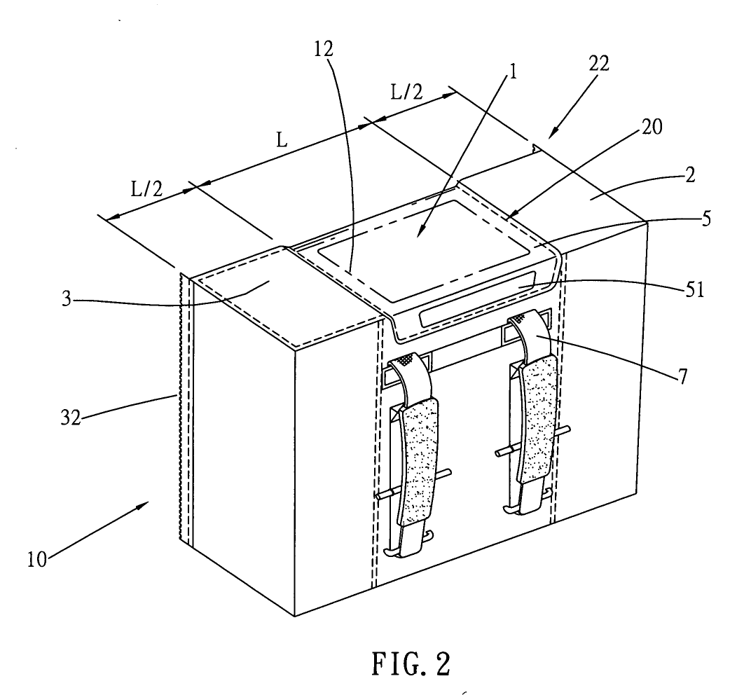

Referring to FIG. 2, which shows an embodiment of the present invention, primarily structured to comprise a basic bag 1, an opening 12, straps 7 and a pull bar 4, wherein the straps 7 are disposed on one side of the basic bag 1 so as to form a back carrying side. The pull bar 4 is disposed juxtaposed to the back carrying side. Transformation portions 2, 3 are respectively connected to two sides of the basic bag 1. An upper end of the basic bag 1 forms the opening 12 to enable the placement and removal of carrying articles therethrough. An upper portion of the opening 12 is covered with a cover portion 20. An embodiment of the cover portion 20 may adopt a top cover 5 configured with a fastening portion 51 positioned in the direction of the straps 7, which enables fixedly clasping the upper end of the basic bag 1 therewith. The fastening portion 51 positioned at one side of the back carrying side is used to prevent another person opening the top cover 5 when carrying the basic bag 1 on the back.

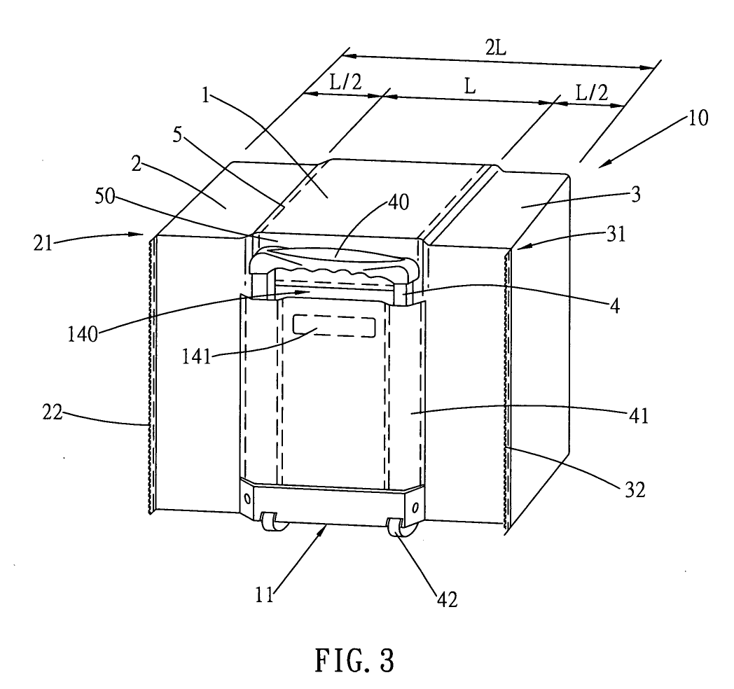

An expanded bag body 10 (largest holding space) is formed after extending the two transformation portions 2, 3, and male and female mutually corresponding joining sides 22, 32 are located on same side corresponding angle ends of the transformation portions 2, 3 respectively. Referring to FIG. 3, if width of the basic bag 1 is set to L, then width of each of the two transformation portions 2, 3 is half of L, and after full extension of the two transformation portions 2, 3 a width of 2L is formed, thereby providing twice the capacity of the basic bag 1 (the aforementioned capacity transformation is under the circumstances that depth and height of the basic bag 1 do not change). Hence, such transformation of width enables direct determination of variation in capacity of the basic bag 1. The advocated ½ spatial transformation of the embodiment is an optimum value. In addition, any range close to a ½ value that comes within the joining scale range of the two joining sides 22, 32 enables a possible capacity transformation to be implemented.

Regarding contraction of the present invention to reduce capacity thereof, a manual pulling method can be used to pull and fasten together the male and female juxtaposed joining sides 22, 32 located on angle edge lines 21, 31 formed by the transformation portions 2, 3, thereby achieving the objective of contracting the basic bag 1 using a method such as zip fasteners.

Furthermore, the basic bag 1 is provided with the pull bar 4 on one side of the correspondingly positioned joining sides 22, 32, and the pull bar 4 can be covered by a covering body 41 and positionally fixed therewith. The pull bar 4 is configured with exposed ground-contacting wheels 42 close to position of a lower angle end 11 of the basic bag 1. The pull bar 4 is an extensible structure, which can either comprise two rods joined to form a squared-off inverted U-shaped configuration, as depicted in the drawings of the present invention, or a single rod extensible pull bar can be used (not shown in the drawings). When the two joining sides 22, 32 are joined, the aforementioned pull bar 4 and covering body 41 are in a state enveloped by the two joining sides 22, 32.

An inner side surface of the basic bag 1 covered by the covering body 41 upwardly extends from the position of the ground-contacting wheels 42 and is situated between the pull bar 4 and the basic bag 1, thereby forming an interlayer 140 that provides for holding thin-shaped articles therein. Juxtaposed fastening members 141 can be located on an inner side of the interlayer 140 to enable fastening together and formation of a sealed inner side.

Implementation of the inner side juxtaposed fastening members 141 can be used to directly connect to position vacated by a handle 40 of the pull bar 4 at a head end 50 of the top cover 5 located on the basic bag 1. However, if an upper portion of the covering body 41 is directly connected to the top cover 5, as depicted in the embodiment of FIG. 3, then implementation of the juxtaposed fastening members 141 of FIG. 2 can be dispensed with.

Furthermore, direct connection of the top cover 5 to the upper end of the covering body 41 can be used to enable simultaneous closing over of the interlayer 140 and the handle 40 of the pull bar 4 and the opening 12 of the basic bag 1.

Joining methods for joining the periphery of the opening 12 to the top cover 5 include using hook and loop fastener strips located on the periphery of the opening 12 and the corresponding periphery of the top cover 5, or buttons or a zip fastening method can be used to fasten the two together, and because such joining methods are known from prior art, thus, they are not described hereinafter. The transformation portions 2, 3 are made form flexible material, such as cloth material, which is easily transformed through manual operation. The transformation portions 2, 3 are structured to comprise five surrounding sides, primarily from first side surrounding sides 211, 311, second side surrounding sides 212, 312 and third side surrounding sides 213, 313 to surround and form inverted squared-off U shapes, upper and lower ends of each of which are enclosed with top sides 214, 314 and bottom sides 215, 315 respectively, and corresponds to an open connecting central interior space formed by connecting sides of the basic bag 1. The transformation portions 2, 3 joined to the basic bag 1 form box-shaped holding spaces provided with an opening that enables access to the entire interior.

During the operating process of contracting the present invention, apart from plane transformation of the first side surrounding sides 211, 311, the second side surrounding sides 212, 312 and the third side surrounding sides 213, 313, moreover, synchronized transformation of end sides of the top and bottom surfaces 214, 314, 215, 315 also occurs. Because transformation of the four end surfaces is as a result of using flexible material, thus, tolerance range of the transformation is enormous. Hence, during the process of contracting the basic bag 1, there is practically no need to take into consideration transformation state of the top surfaces 214, 314 and the bottom surfaces 215, 315, such as kinking and piling.

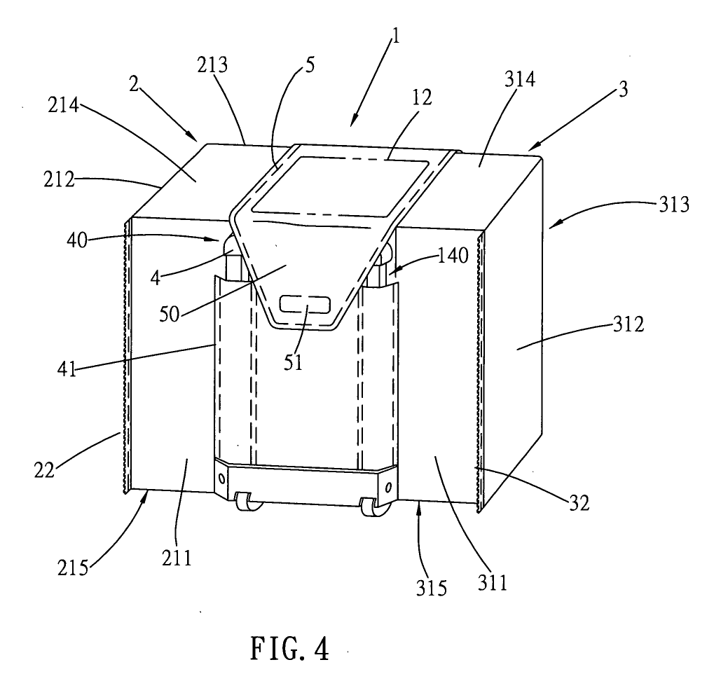

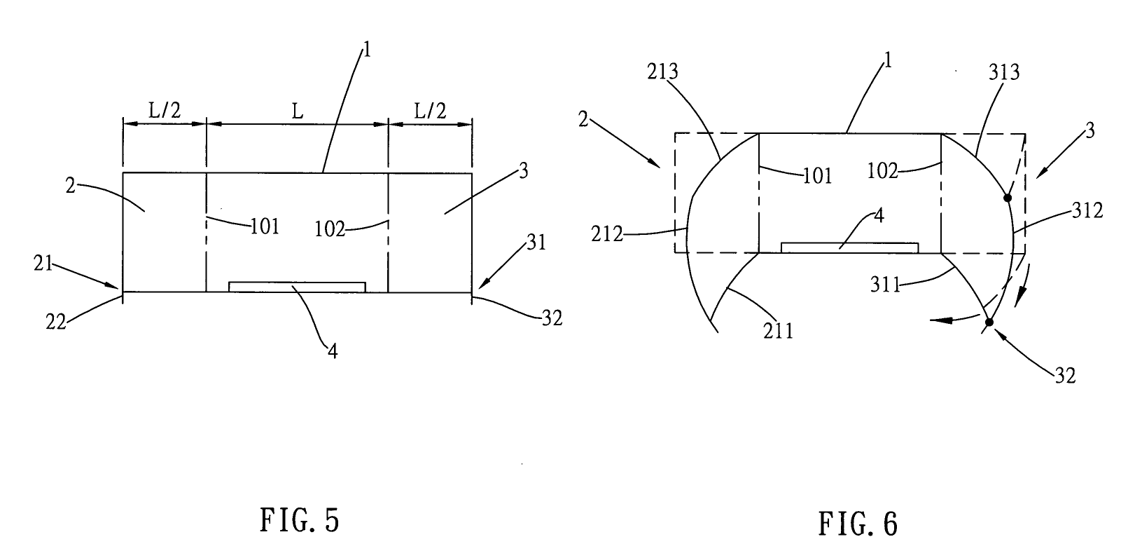

Referring to FIGS. 4, 5, 6 and 7, which depict transformation operation of the basic bag 1, wherein when a user wants to contract the transformation portions 2, 3, then the joining sides 22, 32 formed by the angle edge lines 21, 31 of the respective transformation portion 2, 3 are used to effect corresponding joining. The joining sides 22, 32 can use zip fasteners, fastening members, or hook and loop fastener strips to effect mutual male and female fastening or other means to achieve joining thereof.

Operating steps include first pulling the joining side 22, 32 towards one side of the basic bag 1 in a central direction, whereby, during the process of pulling, the first side surrounding sides 211, 311 contract towards the center, which simultaneously moves in coordination the second side surrounding sides 212, 312 and the third side surrounding sides 213, 313, thereby producing a displacement transformation.

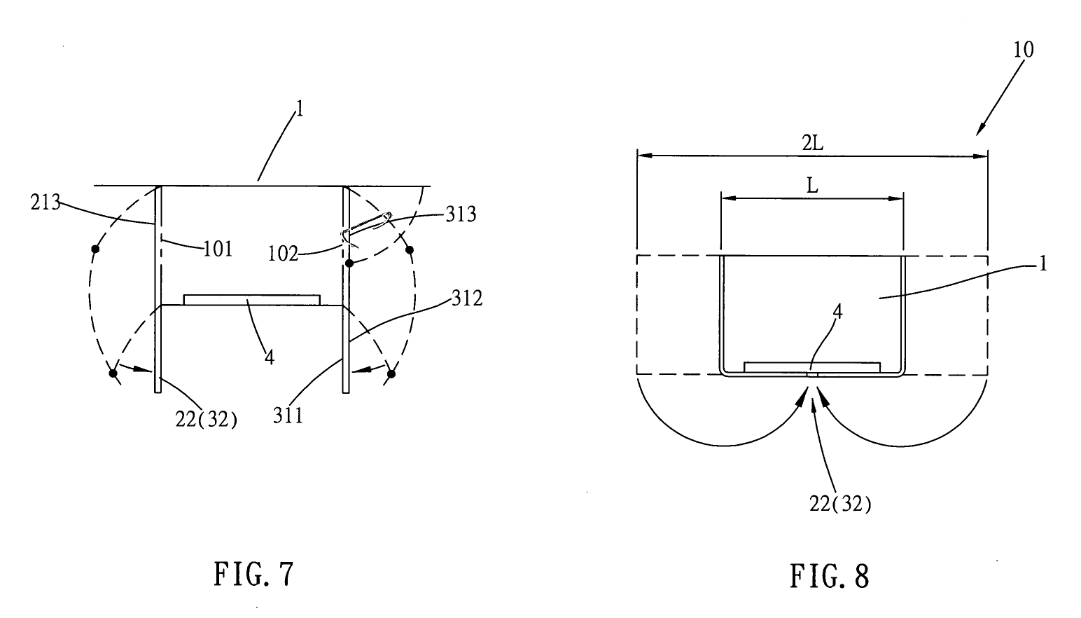

Referring again to FIG. 7, which shows the joining sides 22, 32 pulled to the extreme outer end position, thereby causing the third side surrounding sides 213, 313 to attach to imaginary sides 101, 102 of the basic bag 1 respectively, then the joining sides 22, 32 assemble towards the center of one side of the basic bag 1 and are fastened thereat, thereby forming the state depicted in FIG. 8. Under such a contracted state, the basic bag 1 is formed having a basic width of L. Accordingly, the two joining sides 22, 32 are assembled at one side of the basic bag 1 (position of the pull bar 4), and forms a contracted space having ½ the capacity compared to the largest expanded space of the present invention. The contracted form facilitates carrying on the back of the human body or carrying by hand, forming a portable bag that is convenient to carry when traveling outdoors. A reverse operating procedure can be used on the basic bag 1 after an increased quantity of articles have been purchased when traveling, whereby the joining sides 22, 32 are opened apart, thereby forming the largest expanded bag body 10 to achieve a width of 2L, and which provides the largest holding capacity for use thereof.

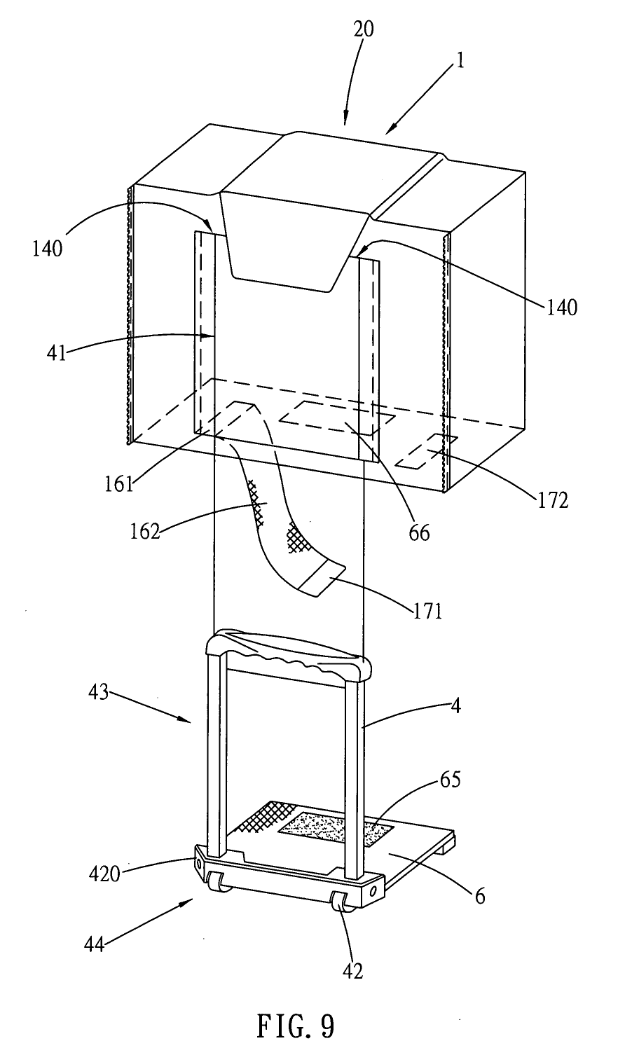

Referring to FIG. 9, an assembly and disassembly function is realized between the pull bar 4 and the basic bag 1 of the present invention by causing the pull bar 4 to pass into and be disposed within the basic bag 1, thereby effecting assembly of the pull bar within the basic bag 1, whereupon the interlayer 140 formed by the covering body 41 envelopes and secures the pull bar. Because the pull bar 4 is a long-shaped structural member, thus, any separating method can be adopted to cause the pull bar 4 to separate from the basic bag 1, and a lower portion of the separated pull bar 4 enables a base plate 6 to be horizontal vertically extended and taken out from wheel mounts 420 of a wheel portion 44. The wheels 42 are located at angle end areas of the wheel mounts 420, and the separating action enables the basic bag 1 to be independently carried on the back by a user. The separated pull bar 4 forms a pull-carrier device 43 that provides an alternative embodiment which can be used to pull other goods. The bidirectional operation enabling the pull bar 4 to be assembled to and disassembled from the basic bag 1 is used to enable the present invention to achieve a detachable or composite multifunctional configuration. The present invention is extremely convenient when the user is out shopping or traveling on a long journey, enabling transformation of form and structure of the basic bag 1 according to different circumstances and quantity of articles carried, thereby providing the basic bag 1 with multifunctionality to accommodate different uses.

The pull bar 4 is assembled to the basic bag 1 by passing through the interlayer 140 and acquiring longitudinal fixing therein, and the transient join between the base plate 6 and the basic bag 1 uses a hook and loop fastener strip 65 located on an upper surface of the base plate 6 to bond to a corresponding hook and loop fastener strip 66 located inside the basic bag 1. Accordingly, such a hook and loop fastener strip method enables achieving the transient join.

In order to enable the base plate 6 to be transiently movable and securely joined to the basic bag 1, apart from the aforementioned embodiments, moreover, an enfold supporting belt member 162 can be adopted to securely enwrap the base plate 6 using an enfolding means. One end of the enfold supporting belt member 162 is a fixed end 161 that is fixed to a bottom portion of the basic bag 1, while a fastening member 171 is formed at the other end that correspondingly fastens to a corresponding fastening member 172 located on the bottom portion of the basic bag 1.

Accordingly, after the pull bar 4 passes through and is disposed in the interlayer 140, then the bottom portion of the base plate 6 uses enfolding of the enfold supporting belt member 162 and corresponding fastening of the end fastening member 171 to the fastening member 172 of the basic bag 1 to form the transient enfolding movable means that enables joining the base pate 6 to the basic bag 1.

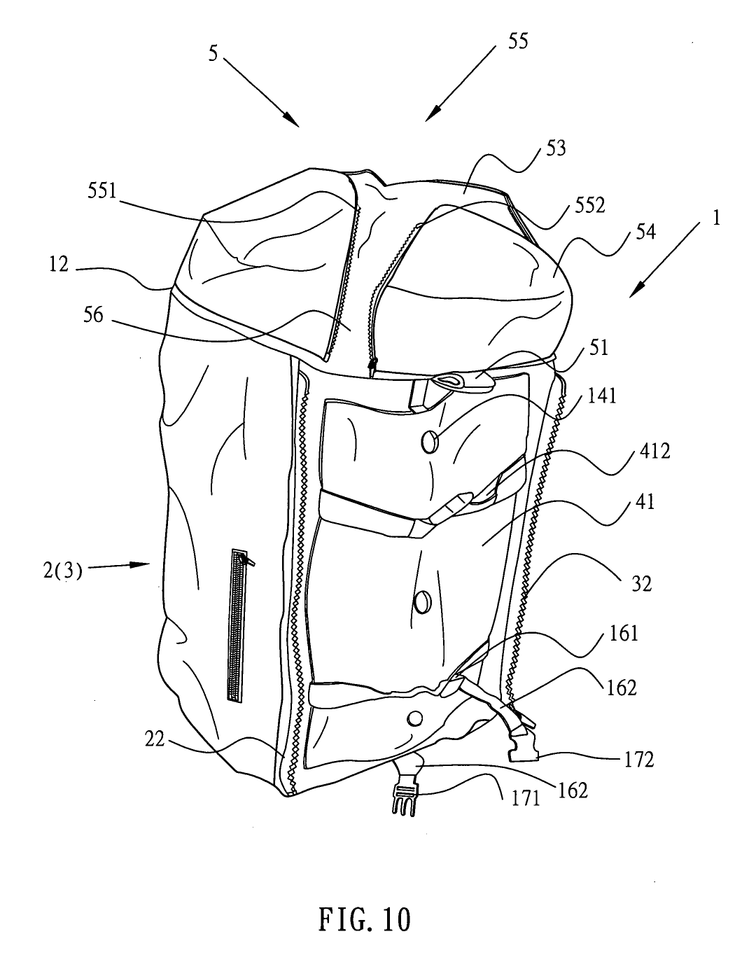

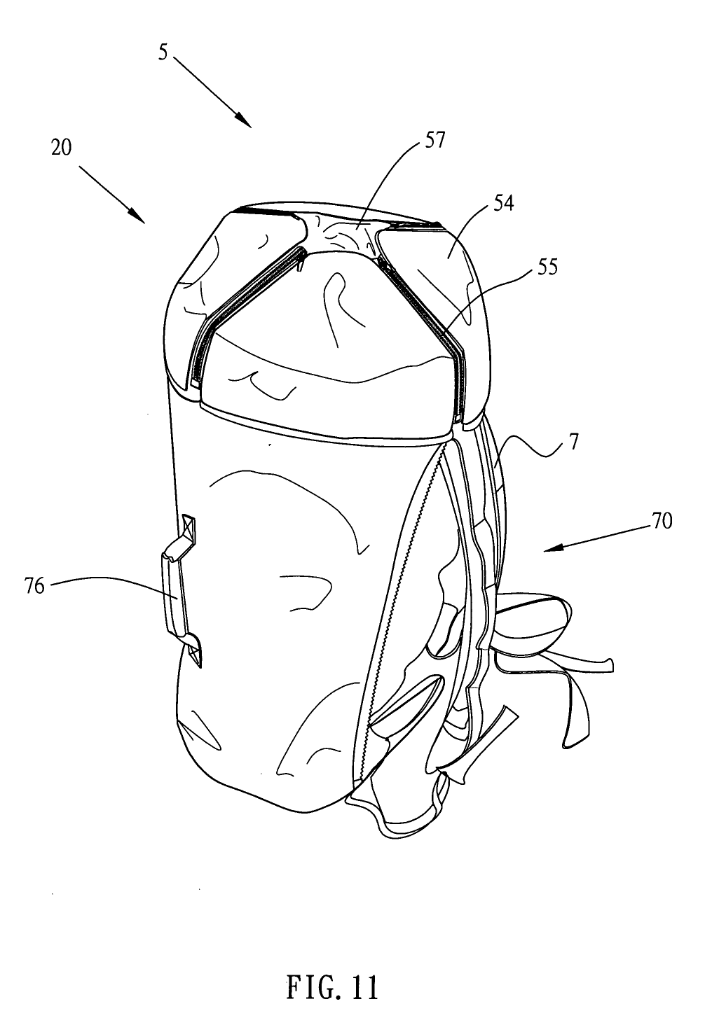

In addition to the aforementioned embodiments, the present invention further utilizes a cylindrical backpack configuration. Referring to FIGS. 10, 11 and 12, which show the present invention comprising the basic bag 1, the upper opening 12, the straps 7 and the pull-carrier device 43, wherein the straps 7 are disposed on one side of the basic bag 1 to form a back carrying side. The pull-carrier device 43 is disposed juxtaposed to the back carrying side, and comprises the pull bar 4, the handle 40 and the wheel portion 44.

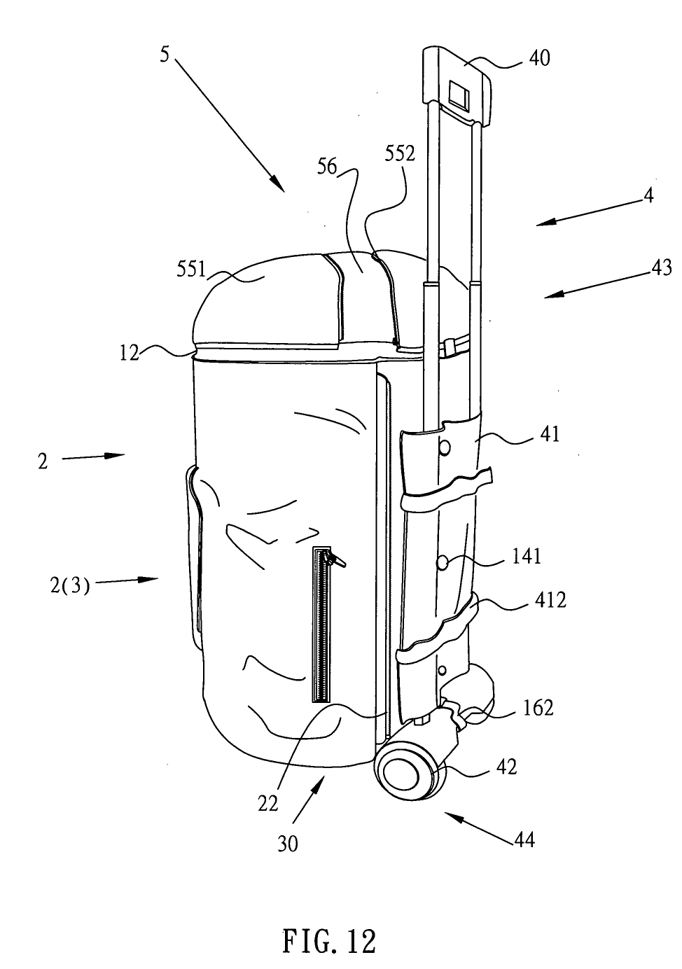

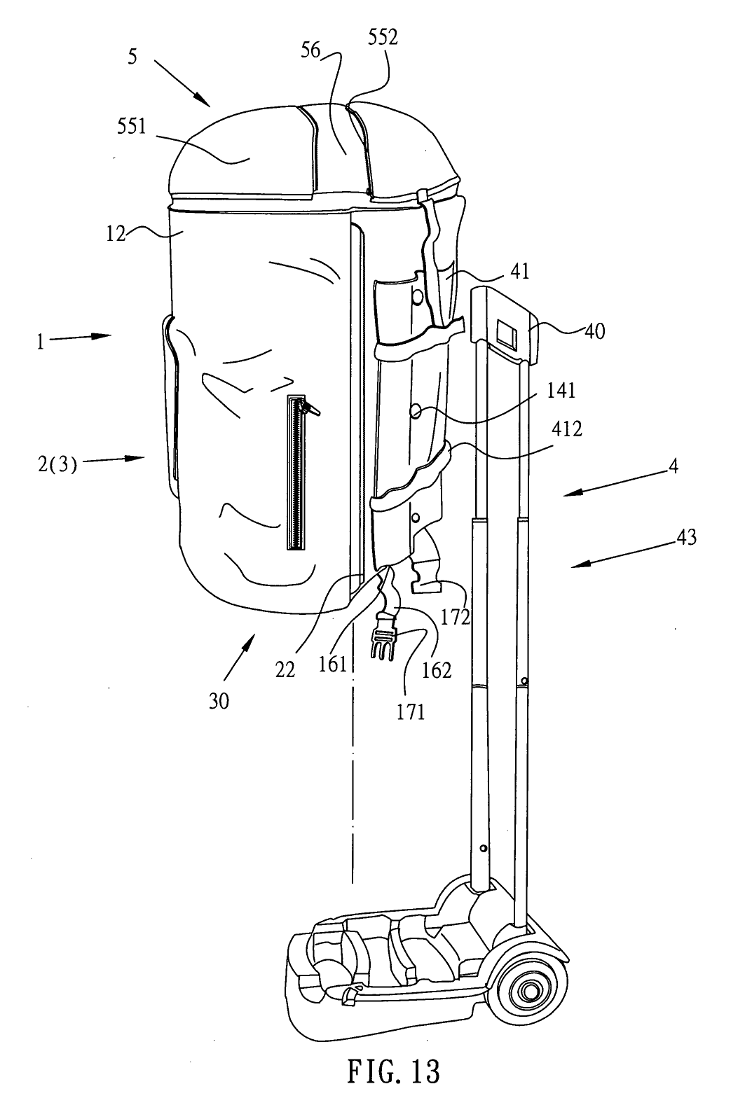

Referring to FIGS. 12 and 13, the pull-carrier device 43 adopts a detachable movable method to assemble to the basic bag 1, and the basic bag 1 is provided with the covering body 41 to secure the pull-carrier device 43. Apart from the covering body 41 being configured with the juxtaposed fastening members 141, moreover, the covering body 41 can be additionally configured with a pull securing member 412 to strengthen securing to the basic bag 1, thereby preventing the pull-carrier device 43 from swaying when pulling the present invention along the ground, and thus increasing stability. In addition, a bottom portion 30 of the basic bag 1 is configured with the enfold supporting belt member 162, one end of which is the fixed end 161, and the other end is provided with the fastening member 171, which after passing through a gap of the pull-carrier device 43 correspondingly fastens to the fastening member 172 located on the lower portion of the covering body 41, thereby securing the pull-carrier device 43 and further increasing stability of the pull-carrier device 43 joined to the present inventions when in use.

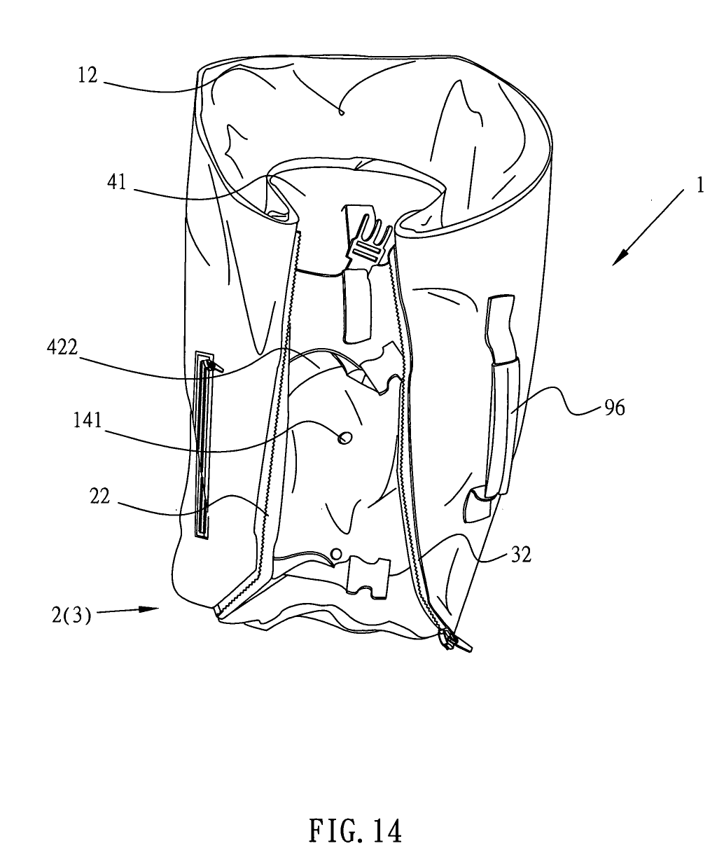

Referring to FIGS. 13 and 14, the transformation portion 2, 3 respectively located on the left and right sides of the basic bag 1 enable transforming the basic bag 1 to provide different capacities of space for disposing articles therein. The transformation portions 2, 3 are further configured with the corresponding joining sides 22, 32 respectively, and although implementation of the joining sides 22, 32 adopts either zip fasteners, hook and loop fastener strips or fastening members, however, zip fasteners are the primary method used in the embodiments of the present invention, thereby, when contracting the backpack, the pull-carrier device 43 is first detached from the covering body 41, and then the joining sides 22, 32 are used to pull together the two sides of the basic bag 1 towards the back carrying side in a central direction, whereupon zip fasteners located on the joining sides 22, 32 are used to mutually fix together, thereby achieving functionality to contract capacity of the backpack.

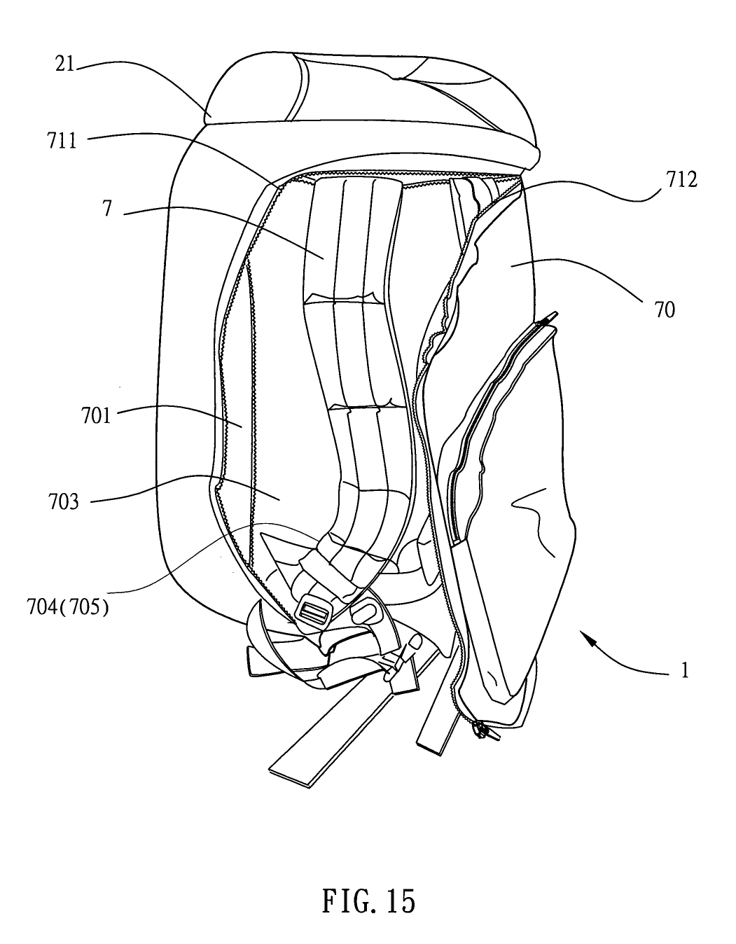

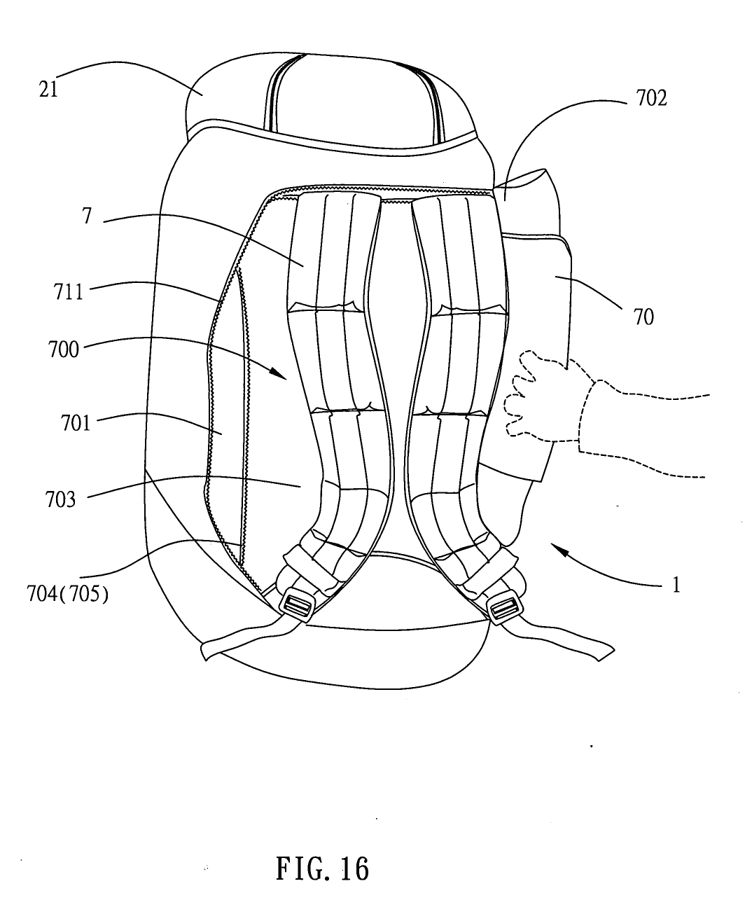

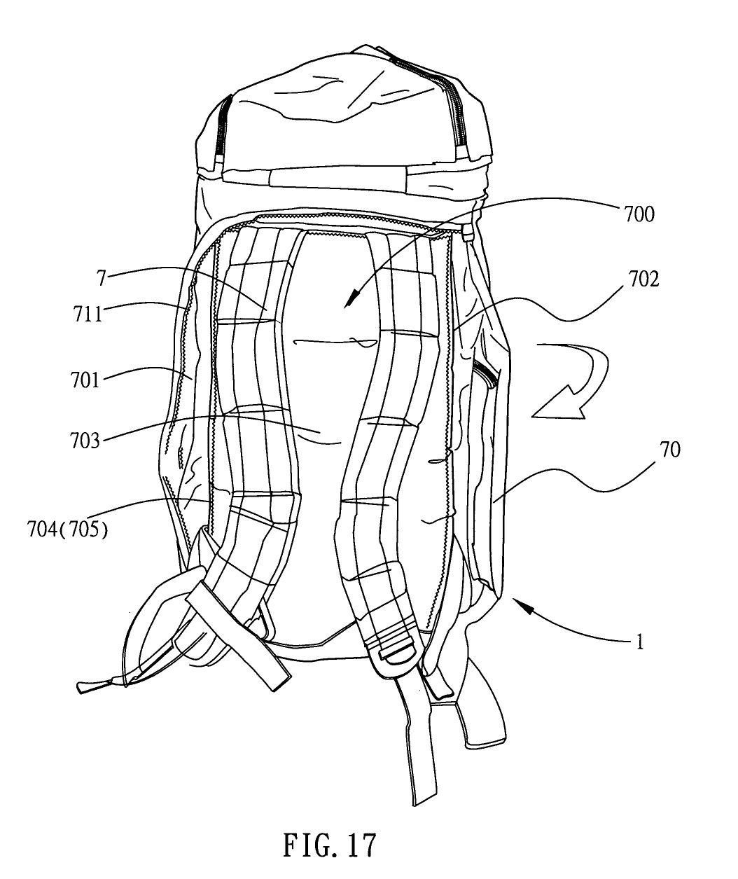

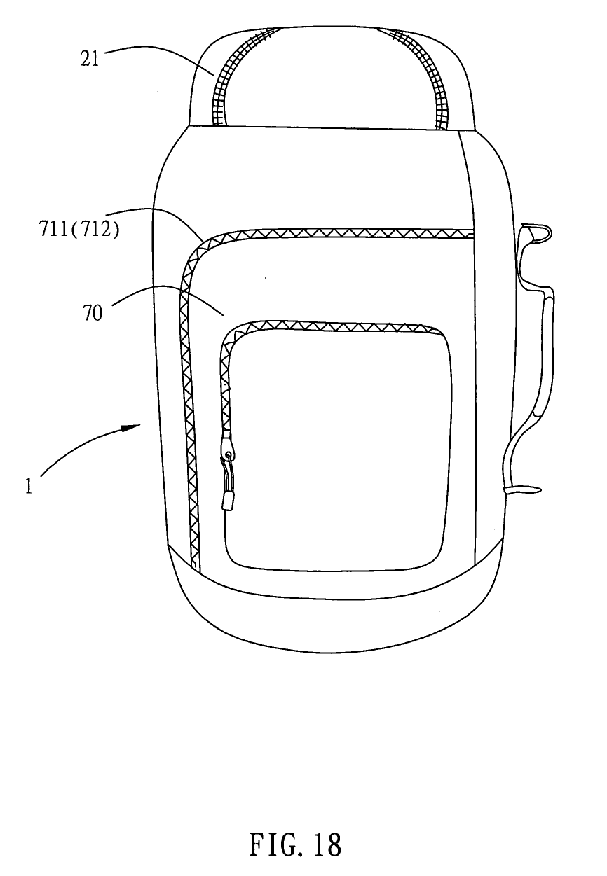

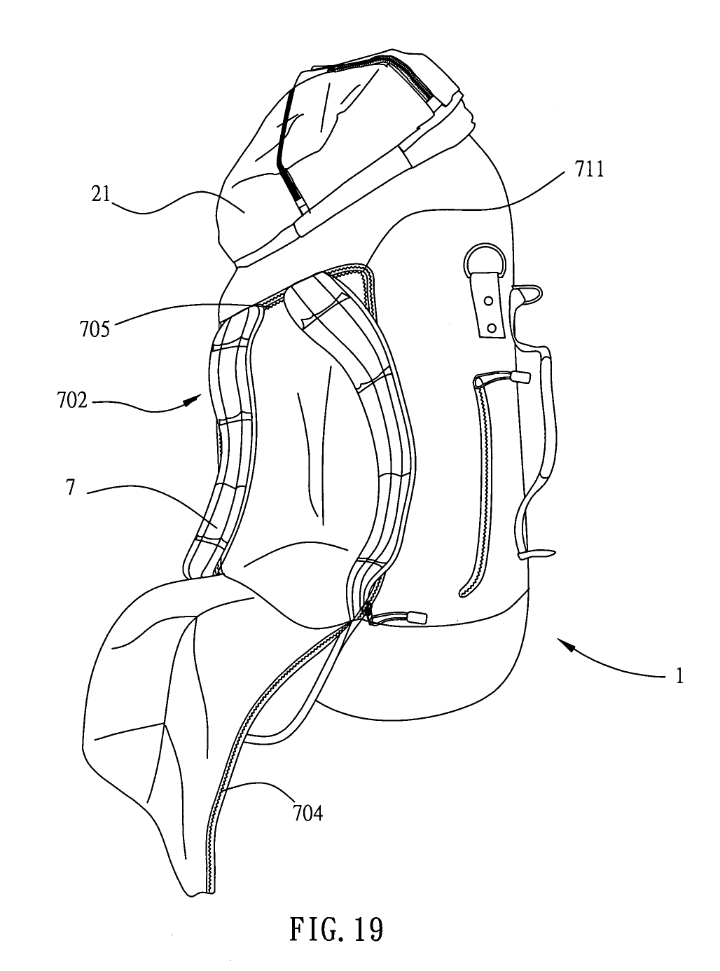

Referring to FIGS. 15, 16 and 17, which show the back carrying side configured with a front cover 70, an inner interlayer 700 and the backsetting straps 7, wherein the basic bag 1 and the front cover 70 are configured with corresponding front cover closing zip fastener teeth 711 and 712 respectively, thereby enabling opening or closing of the front cover 70. After opening the front cover 70, two sides of the inner interlayer 700 positioned corresponding to the front cover 70 are provided with a first side retaining portion 701 and a second side retaining portion 702. When using the straps 7, the front cover 70 is opened, and after folding inward is disposed within the second side retaining portion 702, thereby enabling retaining the opened front cover 70. When the straps 7 are not needed, then the front cover 70 is removed from the second side retaining portion 702, whereafter the front cover closing zip fastener teeth 711 and 712 are used to close the front cover 70, and the straps 7 are sealed between the front cover 70 and the inner interlayer 700 (see FIG. 18). In addition, the inner interlayer 700 positioned between the first side retaining portion 701 and the second side retaining portion 702 can be further configured with a front opening 703. The front opening 703 and the inner interlayer 700 are configured with corresponding front opening zip fastener teeth 704 and 705 respectively, thereby enabling opening or closing of the front opening 703 (see FIG. 19). Apart from a user being able to use the upper opening 12 to dispose articles within or take out articles from the basic bag 1, moreover, the front opening 703 can be used to extract articles which are placed in a bottom layer of the backpack, thereby providing greater convenience of use.

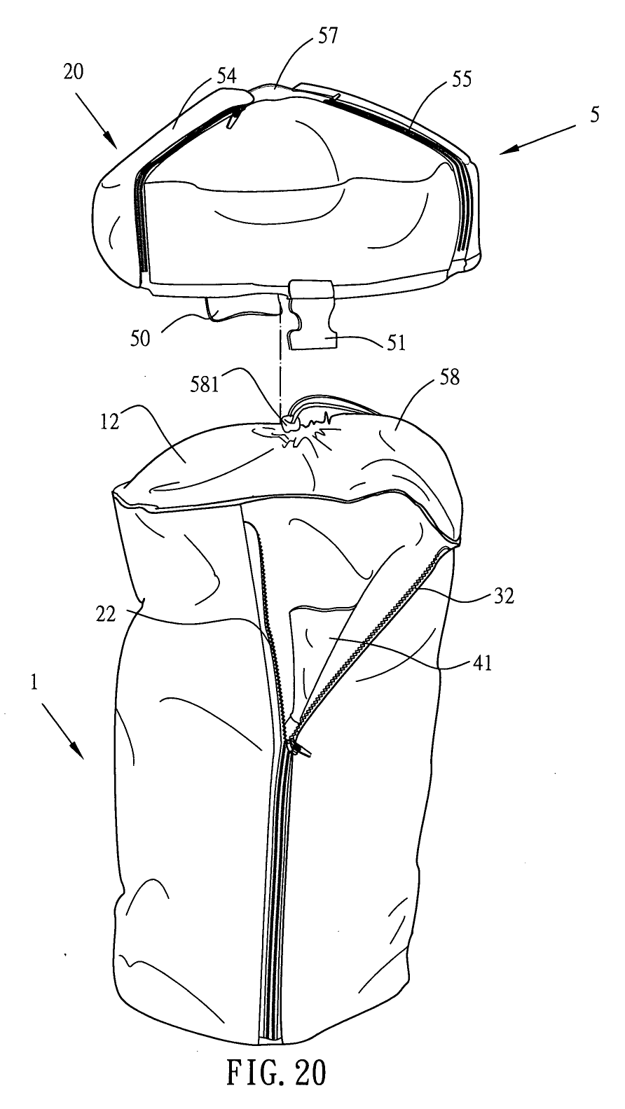

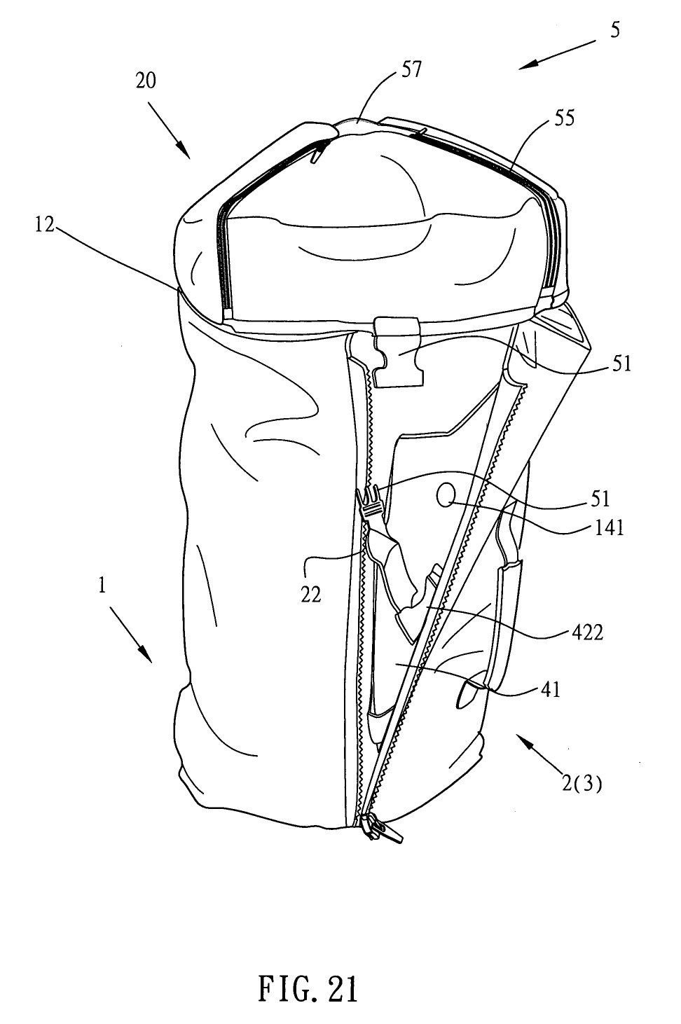

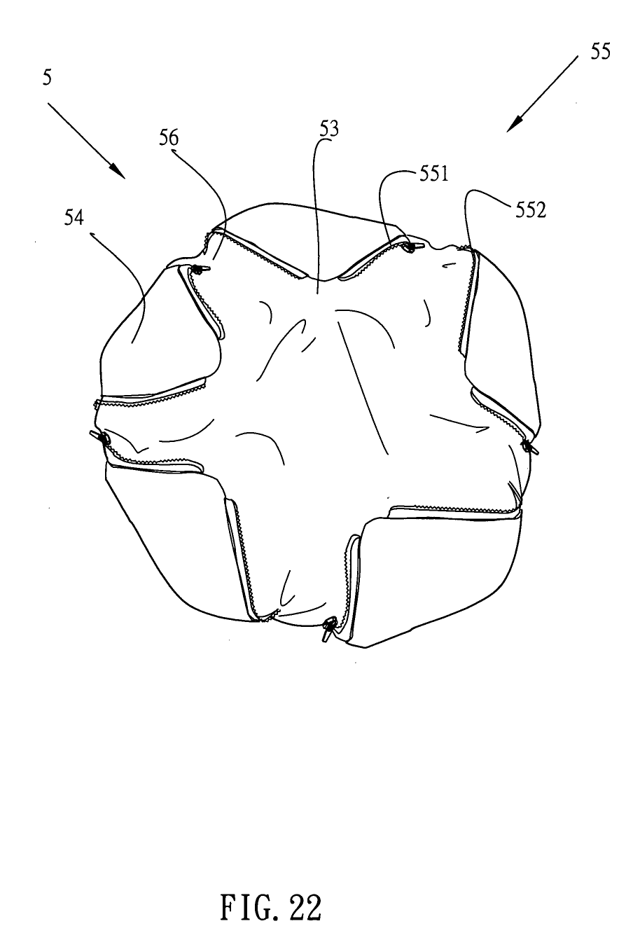

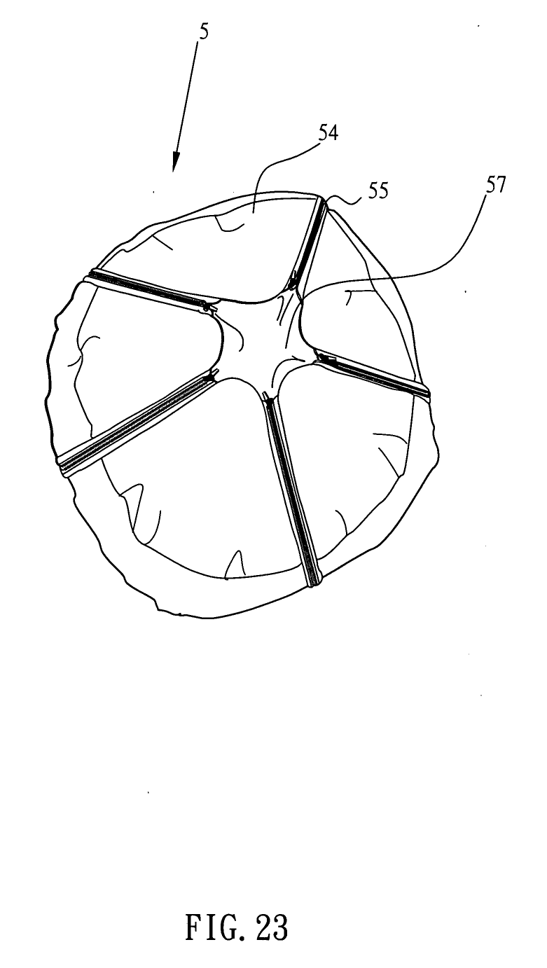

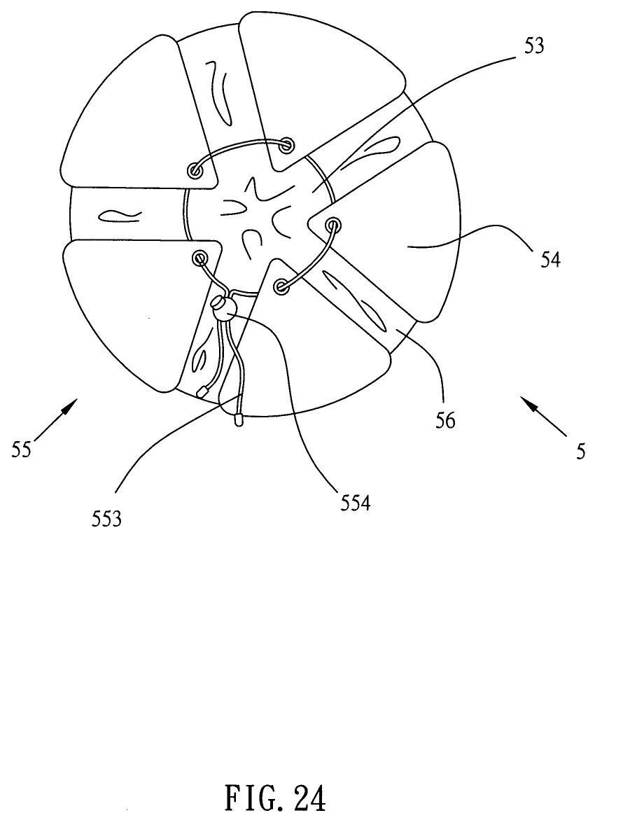

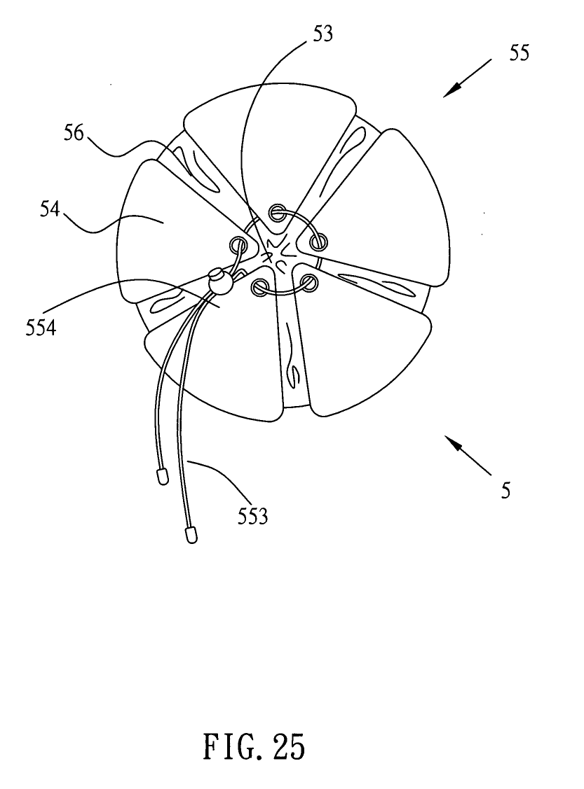

Referring to FIGS. 20 and 21, wherein the upper opening 12 is provided with the cover portion 20 comprising the fastening portion 51, the top cover 5 and a covering piece 58. In addition, a periphery of the upper opening 12 is circumferential provided with the covering piece 58. Moreover, the covering piece 58 further comprises a gathering member 581, which can be used to gather together the upper covering piece 58 over the upper opening 12, thereby preventing articles from falling out of the backpack because of overpacking. Referring to FIGS. 22, 23, 24 and 25, the top cover 5 is formed by joining together an inner strip 53, a plurality of outer strips 54 and a top contracting member 55, wherein implementation of the top contracting members 55 can adopt either zip fasteners, hook and loop fastener strips, a cord or fastening members. However, the present invention uses first radial zip fastener teeth 551, 552 or a cord 553 and an adjusting cord fastener 554 as the preferred implementation methods. The inner strip 53 is fabricated from a single strip of flexible material, and the entire area of the inner strip 53 is larger than the total area of the plurality of outer strips 54. The plurality of outer strips 54 are radially arranged on the upper surface of the inner strip 53, thereby enabling a first transformation area 56 to be formed between the plurality of outer strips 54 and the inner strip 53. Peripheral edges of the plurality of outer strips 54 are configured with the top contracting members 55, and joining the top contracting members 55 causes contraction of the first transformation area 56, thereby forming an area smaller than that of the inner strip 53. According to the aforementioned structure, because the inner strip 53 is fabricated from a single strip of flexible material, thus, the first transformation area 56 formed between the plurality of outer strips 54 and the inner strip 53 effects a configurational state able to achieve expansion and contraction functionality. Referring to FIG. 22, mutually joining of the first radial zip fastener teeth 551, 552 causes the plurality of outer strips 54 to gather together, and the first transformation area 56 contracts to achieve the contracted state depicted in FIG. 23. Referring to FIG. 24, the cord 553 is used to pull and gather together the plurality of outer strips 54, and the adjusting cord fastener 554 secures the cord 553, thereby causing contraction of the first transformation area 56 and achieving the contraction state depicted in FIG. 25.

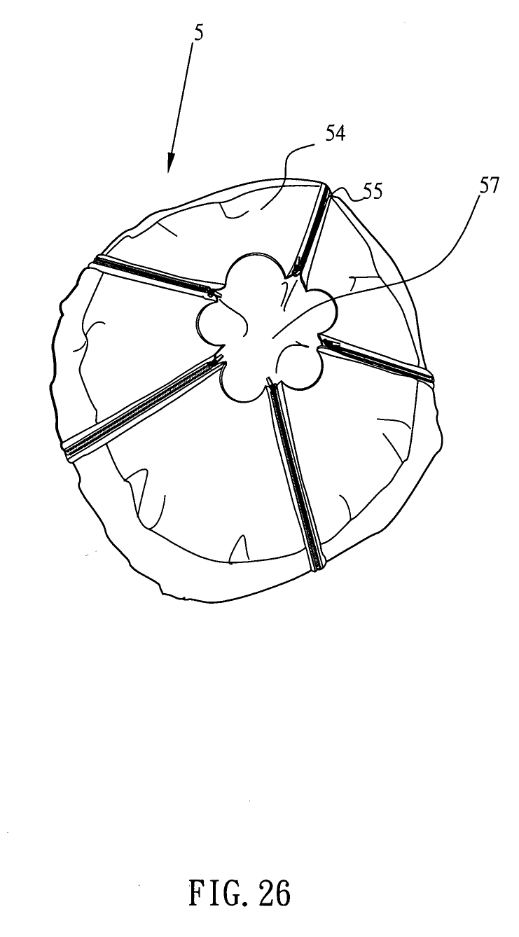

Furthermore, referring to FIG. 26, each of the plurality of outer strips 54 is configured with a notch portion 57, the notch shape of each of which mutually correspond. After using the top contracting members 55 located on the peripheral edges of the plurality of outer strips 54 to effect contraction, then the mutually corresponding notch shapes juxtapose and form an effective integrative combinatorial form. Referring to FIGS. 22 and 24, the notch portions 57 of the embodiment of the present invention are configured on the plurality of outer strips 54 positioned at a central location of the top cover 5, and the corresponding configuration formed after contracting the outer arc-shaped notch of each of the notch portions 57 assumes a five-pointed star shape pattern. Referring to FIG. 26, which depicts another embodiment, wherein the corresponding configuration formed after contracting an inner arc-shaped notch of each of the notch portions 57 assumes a five-petal flower-shaped pattern. According to the aforementioned, the aforesaid embodiments of the notch portions 57 are configured on the plurality of outer strips 54 positioned at the central location of the top cover 5, however, the notch portions 57 can also be configured at other positions of the plurality of outer strips 54 to form corresponding combinatorial patterns that provide different effects (not shown in the drawings).

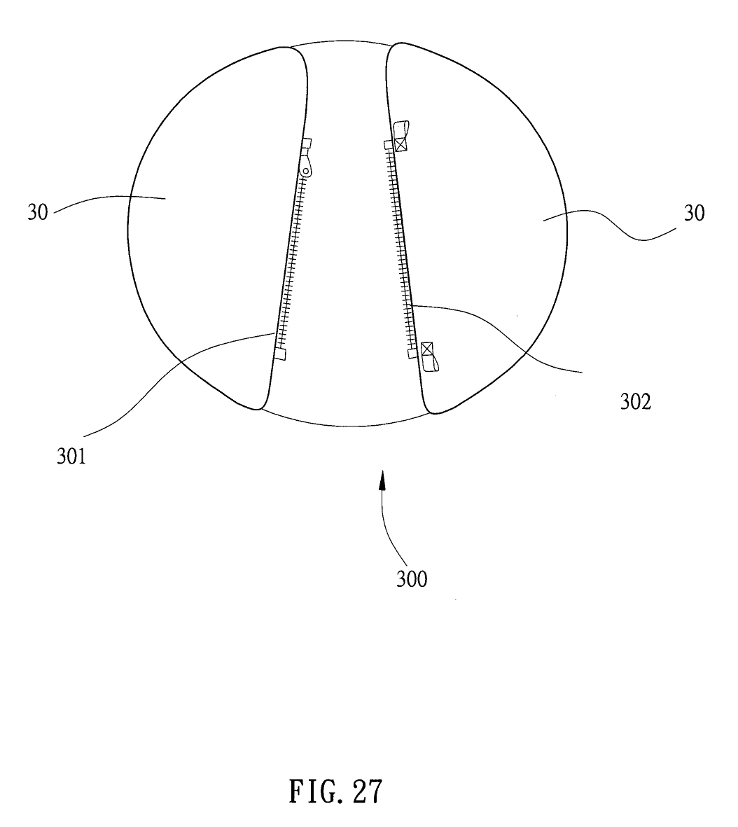

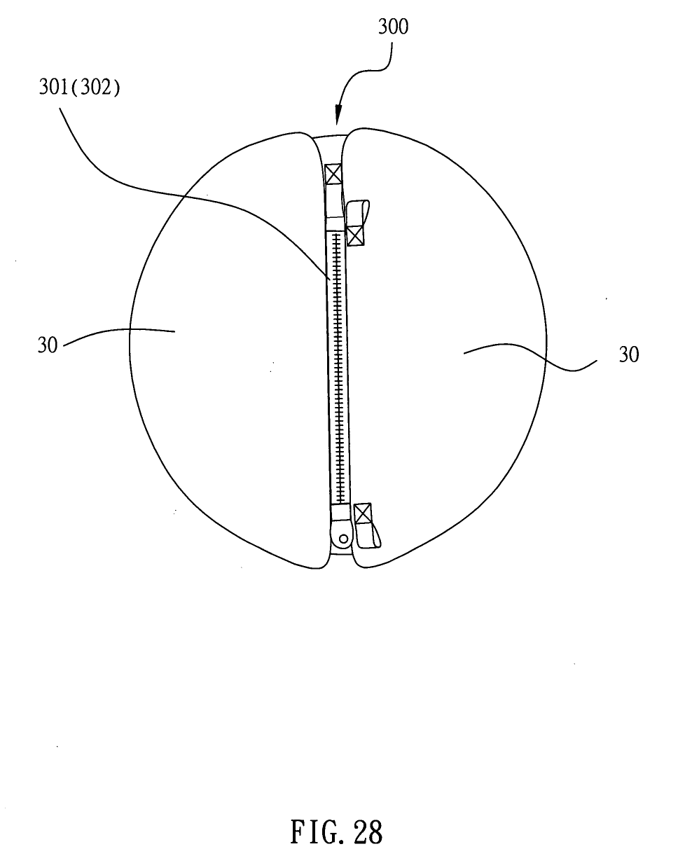

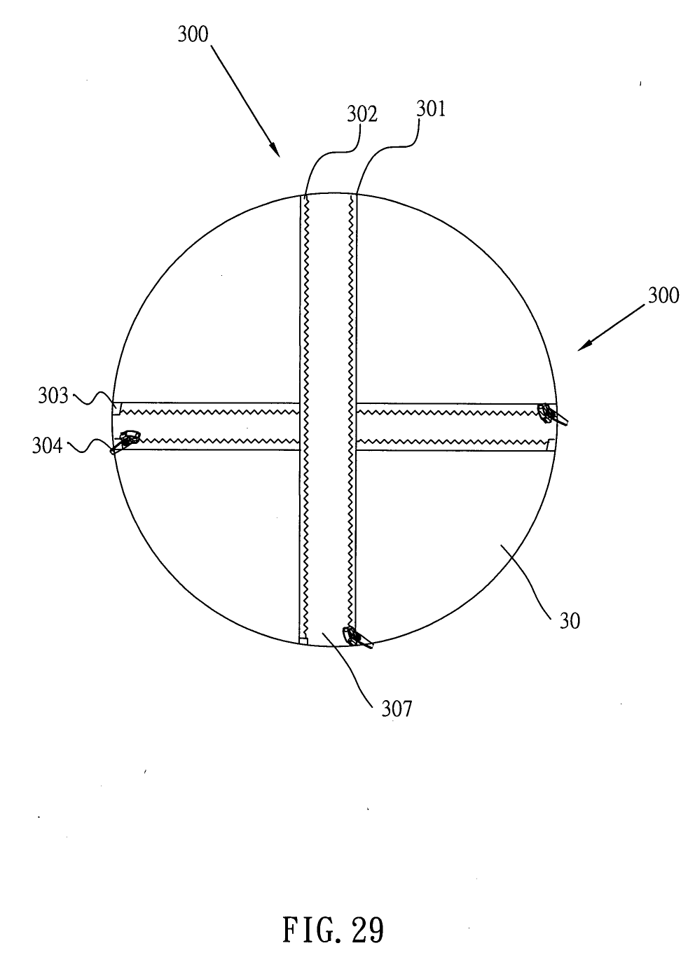

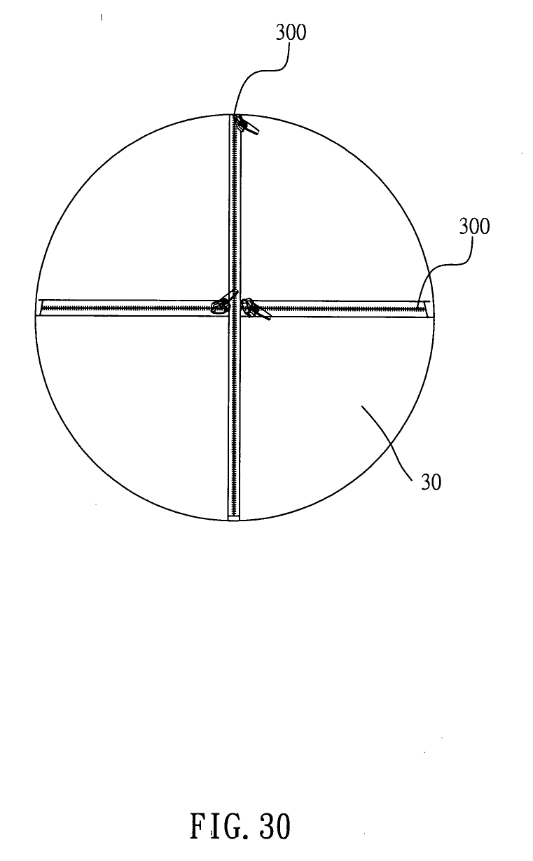

Regarding application of the present invention in a cylindrical backpack configuration, juxtaposition or opening of the joining sides 22, 32 located on the basic bag 1 in conjunction with functioning in coordination with contraction of the top contracting members 55 located on the top cover 5 are used to achieve both expansion and contraction functionality of equal diameter. In addition, referring to FIGS. 27 and 28, which show the basic bag 1 configured with the bottom portion 30 and a bottom contracting member 300, wherein the bottom contracting member 300 are configured with second radial zip fastener teeth 301, 302, and the bottom contracting member 300 may similarly use the second radial zip fastener teeth 301, 302 to function in coordination with a second transformation area 307 configured between the bottom contracting member 300 to achieve contracting of diameter of the bottom portion 30. Furthermore, referring to FIGS. 29 and 30, apart from the bottom contracting member 300 being configured with the second radial zip fastener teeth 301, 302, the bottom contracting member 300 can be further configured with third radial zip fastener teeth 303, 304 to assist the second radial zip fastener teeth 301, 302 in achieving functionality to contract the diameter of the bottom portion 30.

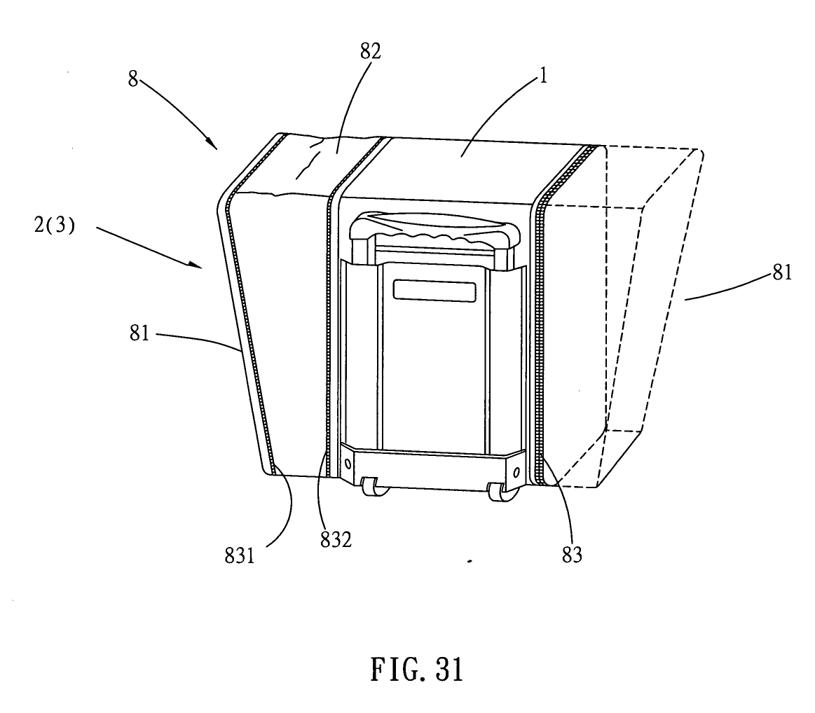

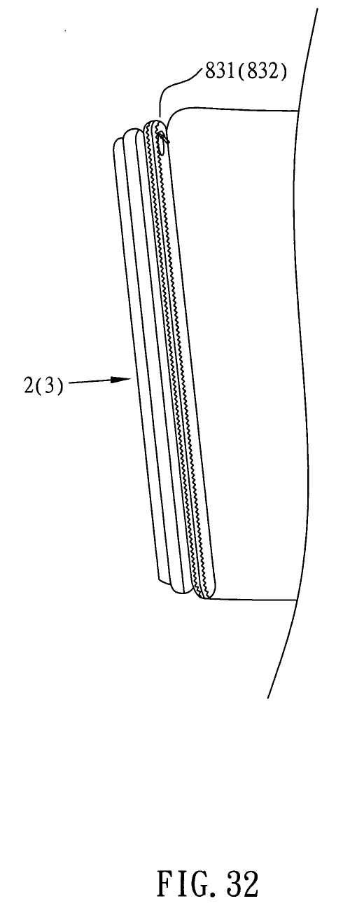

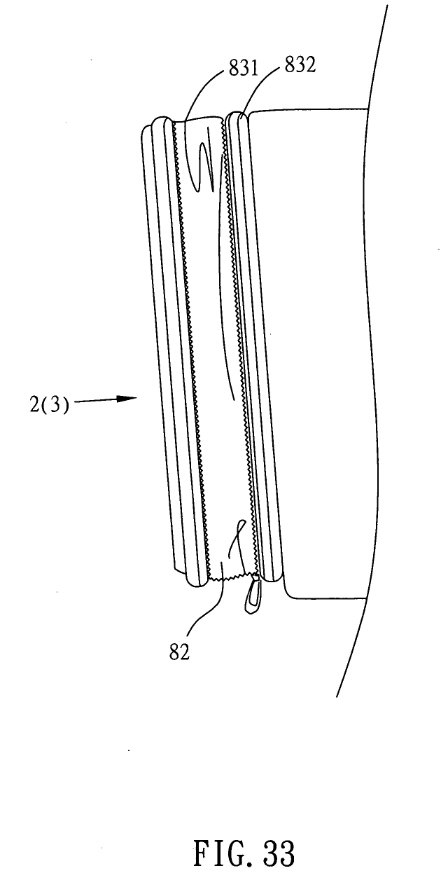

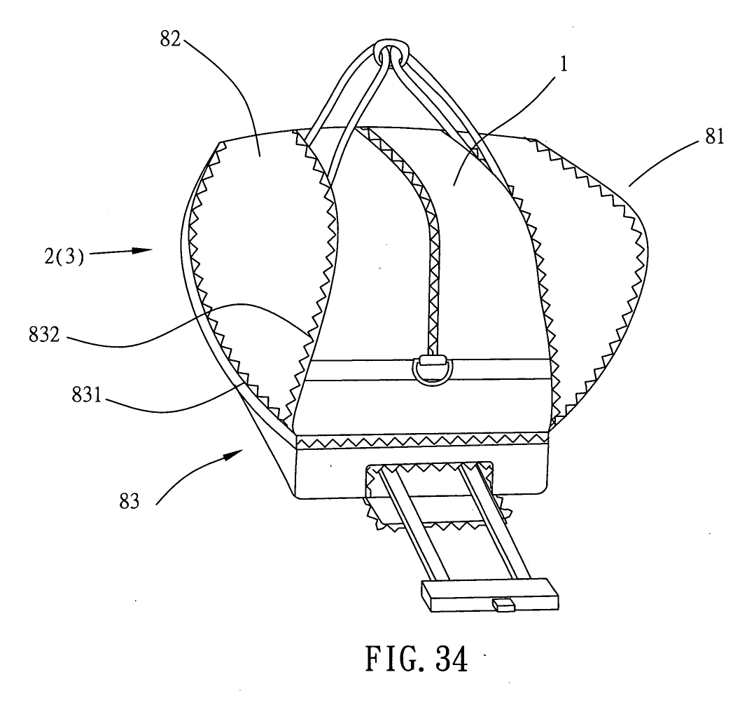

Referring to FIGS. 31, 32 and 33, which show the transformation portions 2, 3 respectively configured on the sides of the basic bag 1 of the present invention to form an embodiment providing expanded capacity, wherein dispositional embodiment of the transformation portions 2, 3 is on the two sides of the basic bag 1, thereby forming expanding portions 8. Each of the expanding portions 8 is formed from a side front cover 81 corresponding to the respective side of the basic bag 1 and connectively configured thereto with a flexible enclosing body 82, and the respective end opening of each of the enclosing bodies 82 is configured with a circumferential zip fastener 83. Accordingly, in a contracted state, the basic bag 1 is formed after joining corresponding lateral zip fastener teeth 831, 832 of each of the enclosing bodies 82. Whereas in an expanded state, after unzipping the circumferential zip fasteners 83, then the lateral zip fastener teeth 831, 832 form an open state, and, through the connectivity of the flexible enclosing bodies 82 connectively configured between the lateral zip fastener teeth 831, 832 of each of the expanding portions 8 and the basic bag 1, transverse expansion is formed between the side front covers 81 and the basic bag 1, thereby increasing internal capacity. The expanding portions 8 of the embodiment situated between the flexible enclosing bodies 82 formed between the lateral zip fastener teeth 831, 832 assume wide-upper narrow-lower forms, that is, length of a bottom surface of each of the flexible enclosing bodies 82 is shorter compared to the length of a top surface thereof, thereby increasing strength of the bottom surfaces and preventing the bottom surfaces of the flexible enclosing bodies 82 from sagging and contacting the ground because of the weight of articles packed in the expanding portions 8 bearing down on the bottom surfaces, resulting in abrasion or soiling of the backpack. The aforementioned embodiments and the flexible enclosing bodies 82 assuming the wide-upper narrow-lower form configuration can be further utilized in portable-type pull-bar wheeled bags (see FIG. 34).

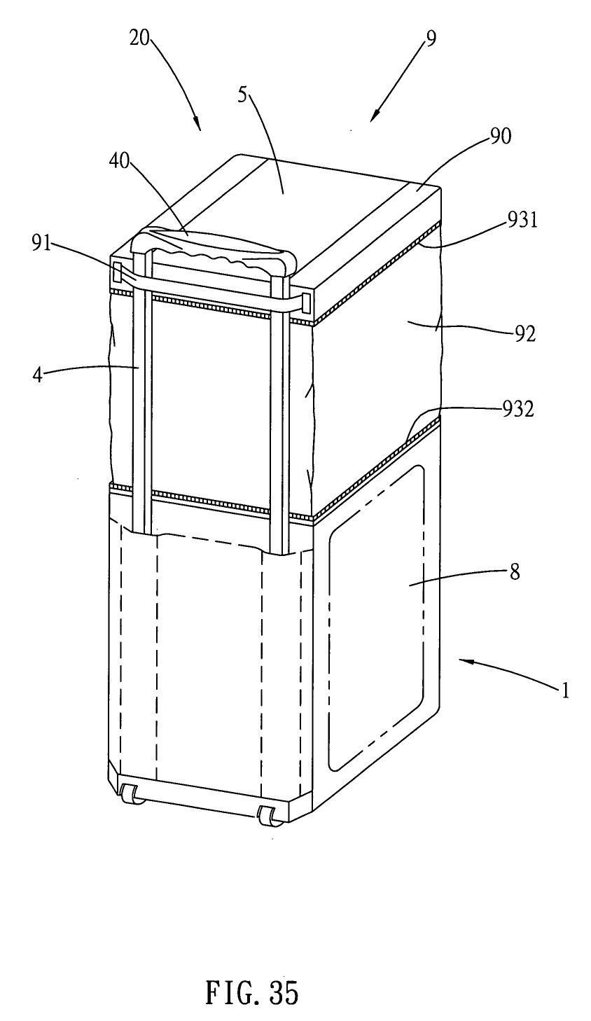

Referring to FIG. 35, in addition to the aforementioned transverse expansion, the present invention also provides the basic bag 1 with the transformation portions 2, 3 vertically configured thereon, which enable forming an embodiment providing upwardly extending expansion capacity. The embodiment is primarily implemented by means of a cover 90 connectively configured to an upper portion of the basic bag 1 with a flexible enclosing body 92. The cover 90 is configured with juxtaposed zip fastener teeth 931, 932 corresponding to an upper end opening of the basic bag 1. The transformation portions 2, 3 enable forming an upwardly expanding extending portion 9 according to expansion state of the flexible enclosing body 92.

When an upper end opening of an upper portion of the cover 90 is covered by the top cover 5 and the cover 90 is positioned on one side of the pull bar 4 to form a girdle 91, then the pull bar 4 is secured, and joining and opening of the two corresponding straight zip fastener teeth 931, 932 is used to activate the flexible enclosing body 92 and form straight contracted and expanded capacities, thereby providing bidirectional functionality.

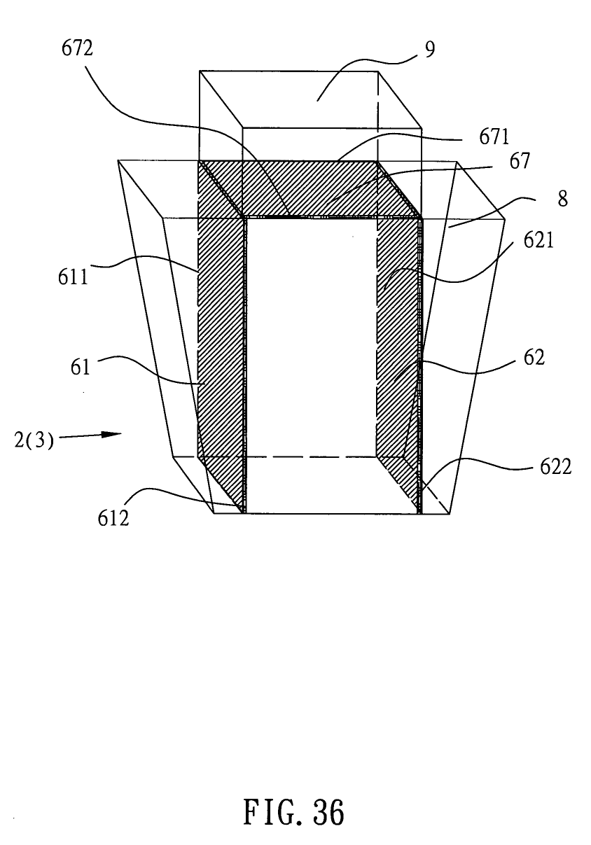

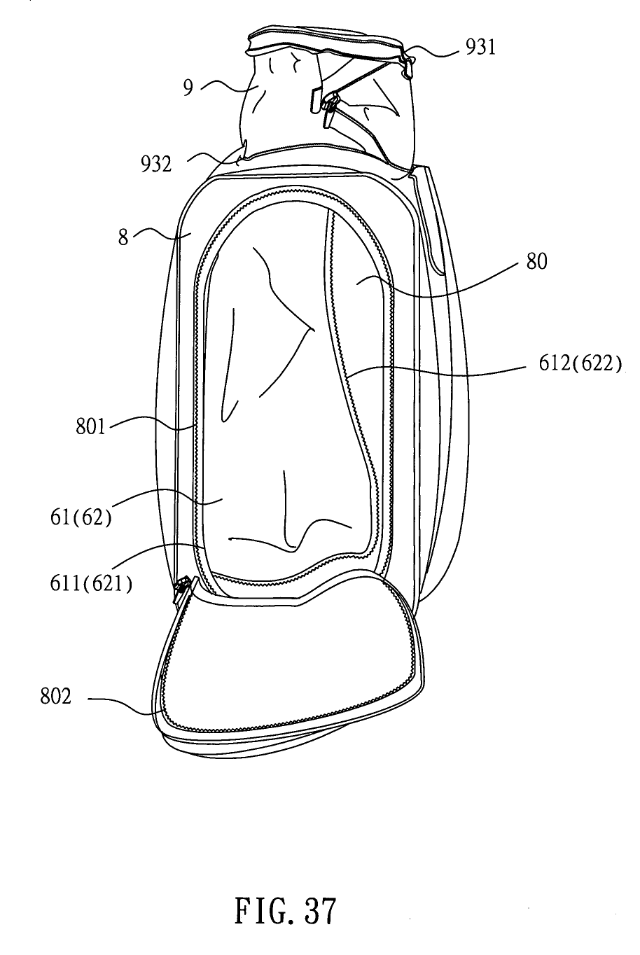

When the straight zip fastener teeth 931, 932 are unzipped, then the cover 90 can be upwardly extended, and, during the process of upward extension, the pull bar 4 can be correspondingly raised and passed through the interspace of the girdle 91, thereby enabling the handle 40 to remain close to the upper end of the cover 90. In addition, because the body of the pull bar 4 is bonded by the girdle 91, thus, the cover 90 is indirectly provided with mechanical attachment, thereby providing the entire upper end with an effective attachment strength after expansion of the extending portion 9, which prevents the extending portion 9 from swaying or displacing due to an external force. Apart from the basic bag 1 of the present invention, as depicted in FIG. 35, forming the straight expanding extending portion 9 structure, the basic bag 1 can be further combined with the structure comprising the transverse extending expanding portions 8 on the sides of the basic bag 1, as depicted in FIG. 31. Actual implementation of the embodiment of such a configuration comprises the basic bag 1 having configured thereto joining of the transverse zip fastener teeth 831, 832 and opening method of the connectively joined flexible enclosing bodies 82 in simultaneous conjunction with the joining of the straight zip fastener teeth 931, 932 and opening method of the connectively joined flexible enclosing body 92, to achieve functionality that provides simultaneous transverse and vertical multiplicative expansion of internal capacity (see FIG. 36). Furthermore, referring to FIG. 37, which shows the expanding portion 8 configured with a side opening 80 and side opening zip fastener teeth 801; the side opening zip fastener teeth 801 being used to facilitate opening of the side opening 80 by a user to place articles within or take articles out of the expanding portion 8 or the basic bag 1.

Referring to FIGS. 36 and 37, spacers 61, 62 are respectively disposed between the basic bag 1 and the expanding portions 8, thereby forming compartments. The spacers 61, 62 are fabricated from a cloth material strip, and at least one side is fixed within the basic bag 1 to form fixed sides 611, and any of the sides apart from the fixed sides 611 are configured with corresponding securing members 612, 622 corresponding to the sides of the basic bag 1. In addition, a spacer 67 can be disposed between the basic bag 1 and the extending portion 9 to form a compartment. The spacer 67 is made from a cloth material strip, and at least one side is fixed within the basic bag 1 to form a fixed side 671, and any of the sides apart from the fixed side 671 is configured with corresponding securing members 672 corresponding to the sides of the basic bag 1. Because the aforementioned spacers 61, 62, 67 are movably configured within the basic bag 1 using the securing members 612, 622, 672, thus, a user is provided with a multitude of flexible choices of whether or not to use the spacers 61, 62, 67 according to how the articles are to be placed within the backpack, or the securing members 612, 622, 672 can be used to evenly dispose the opened spacers 61, 62, 67 within the basic bag 1, thereby achieving functionality to form an integral internally connective configuration and a substantially larger space for retainment of articles therein. Embodiments of the aforementioned securing members 612, 622, 672 comprise at least either zip fasteners, hook and loop fastener strips or fastening members. However, the present invention uses zip fasteners as the preferred embodiment.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A backpack structure combined with pull-carrier device, comprising at least a basic bag and an opening, wherein left and right sides of the basic bag are configured with transformation portions, which are used to enable transforming the basic bag into different space capacities for placement of articles therein; the transformation portions comprise flexible enclosing bodies, and provide expanding and extending functionality.

2. The backpack structure combined with pull-carrier device according to claim 1, wherein the basic bag comprises straps and a pull-carrier device; the straps are disposed on one side of the basic bag to form a back carrying side, and the pull-carrier device is disposed juxtaposed to the back carrying side, and comprises a pull bar, a handle and a wheel portion.

3. The backpack structure combined with pull-carrier device according to claim 1, wherein the pull-carrier device is detachable movably fitted to the basic bag.

4. The backpack structure combined with pull-carrier device according to claim 1, wherein a bottom portion of the basic bag is configured with an enfold supporting belt member to fixedly secure the pull-carrier device; one end of the enfold supporting belt member is configured as a fixed end, and the other end forms a fastening member that fastens to a corresponding fastening member located on the bottom portion of the basic bag.

5. The backpack structure combined with pull-carrier device according to claim 1, wherein the transformation portions are provided with transverse expansion functionality; expanding portions are configured with at least one lateral zip fastener that is used to achieve providing the expanding portions with expanding functionality.

6. The backpack structure combined with pull-carrier device according to claim 1, wherein the transformation portions are provided as an extending portion having upwardly extending functionality; the extending portion is configured with at least one straight zip fastener that is used achieve providing the extending portion with extending functionality.

7. The backpack structure combined with pull-carrier device according to claim 5, wherein the expanding portions are situated between the lateral zip fastener teeth of the flexible enclosing bodies, and assume wide-upper narrow-lower forms, thereby preventing bottom surfaces of the flexible enclosing bodies from sagging and contacting the ground, resulting in abrasion or soiling of the basic bag.

8. The backpack structure combined with pull-carrier device according to claim 5, wherein a spacer is respectively disposed between the basic bag and the expanding portions and the extended portion to form compartments; the spacers are fabricated from cloth material strips, at least one side of each of which is fixed to within the basic bag to form a fixed side; and any of the sides apart from the fixed sides are configured with corresponding securing members corresponding to the sides of the basic bag.

9. The backpack structure combined with pull-carrier device according to claim 1, wherein the opening is configured with a cover portion; and the cover portion comprises a top cover, a head end and a fastening portion.

10. A backpack structure combined with pull-carrier device, comprising a basic bag, an opening, straps and a detachable pull-carrier device, wherein the straps are disposed on one side of the basic bag to form a back carrying side; the pull-carrier device is disposed juxtaposed to the back carrying side, and comprises a pull bar, a handle and a wheel portion; the basic bag is configured with a covering body to secure the pull-carrier device, and the covering body is configured with juxtaposed fastening members to fix to the basic bag; the back carrying side is provided with a front cover, an inner interlayer and a retaining strap, wherein the front cover and the basic bag are respectively configured with corresponding front cover closing zip fastener teeth, thereby enabling opening or closing of the front cover.

11. The backpack structure combined with pull-carrier device according to claim 10, wherein the inner interlayer positioned corresponding to the front cover is configured with a second side retaining portion that is used to retain the front cover after opening thereof

12. The backpack structure combined with pull-carrier device according to claim 10, wherein the inner interlayer is further configured with a front opening; the front opening and the inner interlayer are respectively configured with corresponding front opening zip fastener teeth, thereby enabling opening or closing of the front opening.

13. The backpack structure combined with pull-carrier device according to claim 10, wherein the covering body is configured with a pull securing member for securing to the basic bag.

14. The backpack structure combined with pull-carrier device according to claim 10, wherein a bottom portion of the basic bag is configured with an enfold supporting belt member for securing the pull-carrier device; one end of the enfold supporting belt member is configured as a fixed end, and the other end forms a fastening member that correspondingly fastens with a fastening member located on the bottom portion of the basic bag.

15. The backpack structure combined with pull-carrier device according to claim 10, wherein left and right sides of the basic bag are respectively configured with transformation portions; the transformation portions are used to enable transforming the basic bag into different space capacities for placement of articles therein; the transformation portions are further configured with corresponding joining sides; and the joining sides comprise either zip fasteners, hook and loop fastener strips or fastening members.

16. The backpack structure combined with pull-carrier device according to claim 15, wherein the joining sides the joining sides are used to pull together the two sides of the basic bag towards a central direction of another side of the back carrying side and joined thereat; the joining sides comprise a lateral zip fastener.

17. The backpack structure combined with pull-carrier device according to claim 10, wherein the basic bag is configured with a top cover; the top cover comprises an inner strip, a plurality of outer strips and top contracting members; the top contracting members comprise either zip fasteners, a cord, hook and loop fastener strips or fastening members.

18. The backpack structure combined with pull-carrier device according to claim 17, wherein entire area of the inner strip is larger than total area of the plurality of outer strips; the inner strip is fabricated from flexible material; the plurality of outer strips are radially arranged on the surface of the inner strip, thereby enabling a transformation area to be formed between the plurality of outer strips and the inner strip.

19. The backpack structure combined with pull-carrier device according to claim 10, wherein the top contracting members are respectively configured on peripheral edges of the plurality of outer strips; after joining the plurality of outer strips using the top contracting members, the transformation area is contracted below the plurality of outer strips, thereby forming an area smaller than that of the inner strip.

20. The backpack structure combined with pull-carrier device according to claim 17, wherein the plurality of outer strips are respectively configured with notch portion; and notch shape of each of the notch portions enables forming an effective integrative combinatorial form after contraction of the top contracting members configured on the edges of the plurality of outer strips.

21. The backpack structure combined with pull-carrier device according to claim 19, wherein a peripheral edge of the opening is configured with a covering piece; the covering piece further comprises a gathering member, and the gathering member is used to gather together the covering piece.

22. The backpack structure combined with pull-carrier device according to claim 19, wherein the basic bag comprises the bottom portion, and the bottom portion further comprises bottom contracting member; the bottom contracting member comprises either zip fasteners, hook and loop fastener strips or fastening members.

23. The backpack structure combined with pull-carrier device according to claim 21, wherein the bottom contracting member comprises at least one second radial zip fastener.
